(19) United States
(12) Patent Application Publication
(10) Pub. No.: US 2009/0045600 A1
(43) Pub. Date: Feb. 19, 2009

(54) BICYCLE CRANKSET

(76) Inventor: Michel Garnier, Windhof (LU)

Correspondence Address: YOUNG & THOMPSON, 209 Madison Street, Suite 500, ALEXANDRIA, VA, 22314, US

(21) Appl. No.: 12/093,953

(22) PCT Filed: Nov. 9, 2006
(86) PCT No.: PCT/FR2006/002494

§ 371 Date: Sep. 8, 2008

(30) Foreign Application Priority Data
Nov. 16, 2005 (FR) 0511607

(51) Int. Cl. B62K 3/02

(52) U.S. Cl. 280/281.1

(57) ABSTRACT

A bicycle crankset (1) mounted on the frame (3) of the bicycle, two cranks (7, 9) and at least one chainring (25), the cranks being connected at their axial end (15, 17) by a connecting spindle (31). It is noteworthy in that the connection of the crankset to the frame is provided by means of assembling the axial ends to the frame, thus mechanically relieving the connecting spindle and reducing the dimensions of the connecting spindle and the distance “e” between the axial ends. The crankset is also noteworthy in that each crank takes a pedal which is fitted directly to the crank. This helps to reduce the weight of the crankset.

The present invention relates to a bicycle crankset such as for a racing bike, a mountain bike, or even for motor-assisted bicycles requiring the use of a crankset to start the motor. It will find most particularly the application thereof with manufacturers and with bicycle dealers.

The cranksets are generally assembled in rotation on the frame of the bicycle and are subjected to a rotary motion generated by the pedalling exerted by a cyclist, the rotary motion of the crankset driving via a chain or a transmission belt one of the wheels of the bicycle, generally the rear wheel.

The crankset consists in part of two cranks and at least one chainring rigidly connected to said cranks, the two cranks being connected to each other at their axial end by means of a connecting spindle, more commonly known as the crank axle, said spindle being housed in a housing on the frame of the bicycle; the cranks are arranged at one hundred and eighty degrees in relation to each other and each have at the radial end thereof a pedal, the pedalling of the cyclist exerting a force on the pedals resulting in a radial force and a tangential force on the cranks, said tangential force generating the rotation of the chainring.

The following documents are known which disclose a crankset assembly on a bicycle frame; U.S. Pat. Nos. 5,493,937; 4,545,691; AT 389.499; U.S. Pat. No. 4,651,590; FR 2.465.630; DE 93.15.940. In said documents, the assembly of the crankset on the frame of the bicycle is produced by assembling the connecting spindle, or the axial ends of the cranks, pivotally connected, for example via means of bearings mounted inside the housing of the frame of the bicycle. According to said type of assembly, the forces exerted on the cranks during pedalling are therefore transferred to the connecting spindle directly or indirectly via the axial ends of the cranks. Consequently, the connecting spindle is subjected to torsion stresses resulting from the tangential forces exerted on the cranks and from the resistance exerted by the chain, or the transmission belt which engages with the chainring. Said spindle is also subjected to bending stresses originating from the radial forces exerted on the cranks and which are transferred directly to the ends of the connecting spindle rigidly connected to said cranks.

The connecting spindle is therefore permanently subjected to bending and torsion forces during pedalling, the intensity of the forces varying according to the conditions of use of the cyclist; the connecting spindle of current cranksets is therefore generally designed in steel, which provides same in particular with a good mechanical resistance to the bending stresses, possibly preventing the risks of breakage of the spindle in extreme conditions of use. The use of steel however has the disadvantage of increasing the weight of the crankset and therefore that of the bicycle; which counters the reduction of the weight of bicycles which represents one of the main aims of all manufacturers, and most specifically producers of competition bikes.

The cranks are generally mounted on the axial ends of the connecting spindle. Said connecting spindle therefore has a length at least equal to the width of the housing of the frame of the bicycle increased by the width of the two axial ends of the cranks. For ergonomical reasons, the pedals must be spaced a suitable distance apart in order to provide comfort to the cyclist and to optimise the pedalling force; said distance is nevertheless close to the length, of the connecting spindle, such that cyclists often rub their ankles on the cranks during pedalling, consequently causing injuries, or even bleeding.

U.S. Pat. No. 5,493,937 provides an assembly of the extension of the axial ends of the cranks inside the housing of the bicycle frame. Likewise, U.S. Pat. No. 4,545,691 provides inserts enabling the assembly of the extension of the axial ends of the cranks inside the housing of the bicycle frame. However, this type of assembly also requires a distance or a spacing between the axial ends of the cranks greater than the width of the housing of the bicycle frame, said distance or spacing corresponding to the space required between the pedals to offer ease of pedalling to the cyclist and to optimise the pedalling force.

The aim of the present invention is to remedy such disadvantages by proposing a bicycle crankset enabling the weight of the bicycle to be reduced and injury of the cyclist to be prevented.

To this end, the invention relates to a bicycle crankset such as for a bike, mounted in rotation on the frame of said bicycle according to an axis of rotation perpendicular to the plane of the frame, said crankset consisting of two cranks arranged on either side of the plane of the frame, of at least one drive chainring adjacent to one of the cranks and rigidly connected to same, said cranks being connected by the axial end thereof to a connecting spindle the axle of which corresponds to the axis of rotation of the crankset, said connecting spindle transferring to the chainring the tangential forces exerted on the cranks during pedalling causing the rotation, of said chainring; the invention is noteworthy in that the assembly of the crankset on the bicycle is provided by assembly means pivotally connected between the axial ends of the cranks and the frame of the bicycle, said pivotally connected assembly means consisting of two mounting rings attached to the frame, two bearings, the axial ends of the two cranks, and means for stopping in the sliding motion of the two cranks, said bearings having their inner housing mounted on the rings, and their outer housing mounted on the axial ends of the cranks, thus, on one hand, mechanically relieving the connecting spindle and reducing the dimensions thereof and, on the other hand, reducing the distance between the axial ends of the cranks.

The invention advantageously enables a softer material to be used for the design of the connecting spindle via the elimination of bending stresses which are no longer exerted on said spindle but on the frame of the bicycle; the spindle may therefore be designed in a material that is lighter and resistant to torsion stresses, thus helping to reduce the weight of the bicycle. The design of the crankset according to the invention has in addition the advantage of mounting the axial end of the cranks directly on the housing of the frame, or on an insert on the housing of the frame, reducing the distance between the two cranks, which helps to reduce the dimensions of the spindle and has the advantage of improving the ergonomy of the bicycle and freeing up the space occupied by the ankles of the cyclist during a pedalling cycle, thus reducing the risks of injuries.

Other advantages and features of the present invention will emerge from the description which, will be given and is based on a non-limiting example of the invention in reference to the appended drawings wherein:

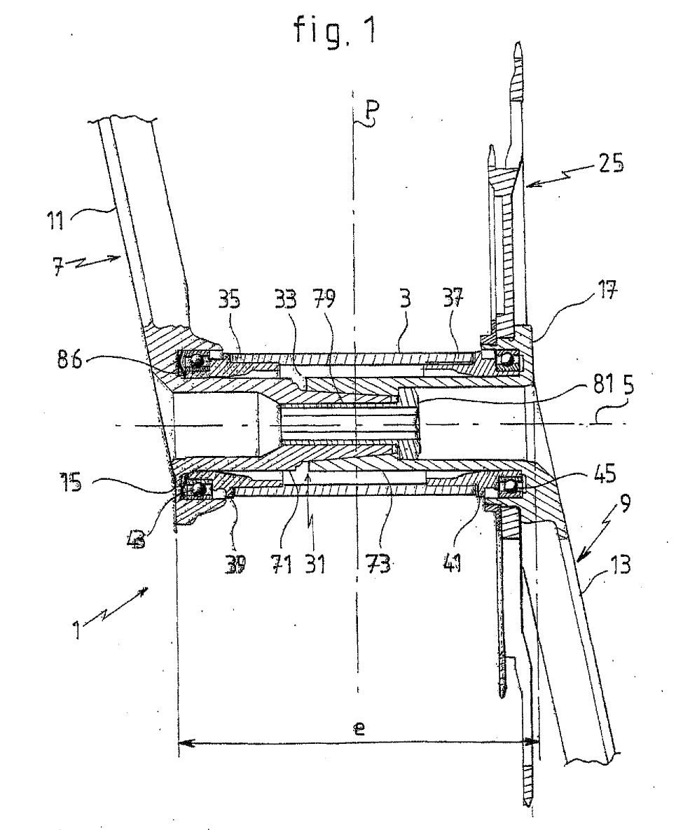

FIG. 1 shows in axial vertical cross-section a crankset according to the invention assembled on a bicycle frame,

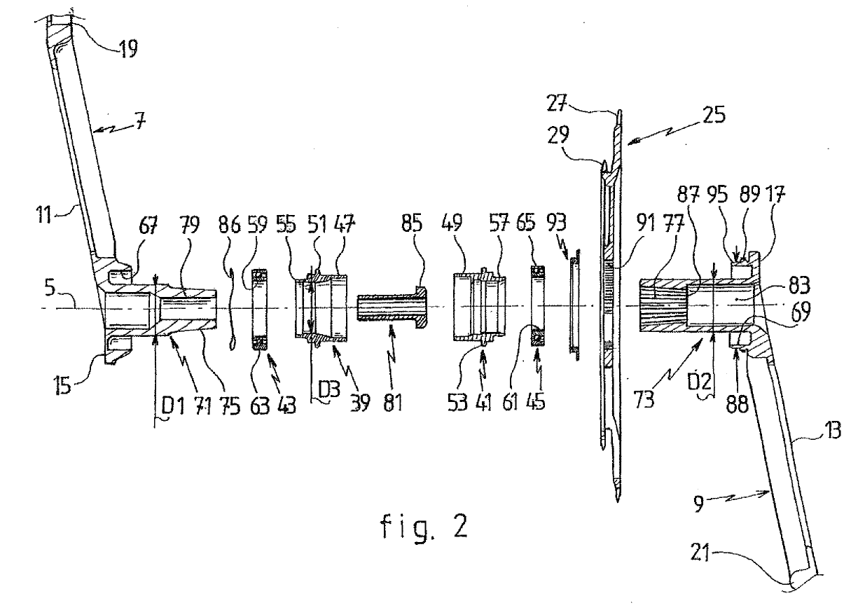

FIG. 2 shows an exploded view of the crankset only as shown in FIG. 1,

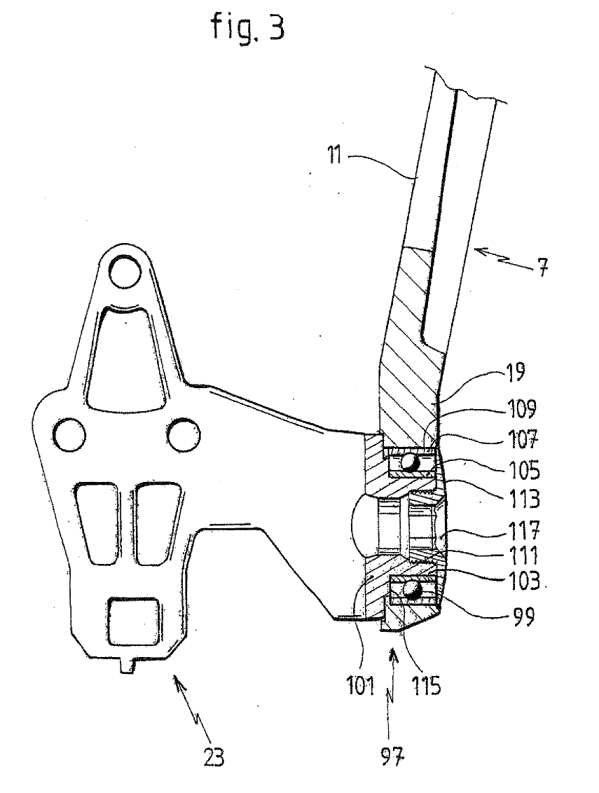

FIG. 3 shows in partial cross-section a mode of assembly of a pedal on a crank of the crankset in accordance with the present invention.

The bicycle crankset 1 subject matter of the present invention is in particular intended for bicycles of the racing bike or mountain bike type in particular those used for taking part in competitions or for intensive use. The crankset 1, shown in FIG. 1, is mounted on the frame 3 of the bicycle and it is in rotation in relation to same according to an axis of rotation 5 perpendicular to the longitudinal plane “P” of the frame 3 of the bicycle, said plane “P” coinciding, in normal conditions of use, with the sagittal plane of the cyclist when he is in seated position on the bicycle.

Referring to FIGS. 1 and 2, the crankset 1 consists of two cranks 7, 9 consisting of a body 11, 13 acting as a lever arm when the cyclist pedals, an axial end 15, 17 arranged in the axis of rotation 5 of the crankset 1, and a radial end 19, 21 whereon is a attached a pedal 23 such as same shown in FIG. 3. In a preferred and non-limiting embodiment, the pedals used are those described in the French patent FR 2846724. The cranks 7, 9 are arranged on either side of the plane “P” at equal distance, and offset, by one hundred and eighty degrees (180°) in relation to each other according to the axis of rotation 5; the two cranks 7, 9 are therefore antisymmetrical in the mark defined by the plane “P” and the axis of rotation 5.

The crankset 1 also comprises at least one axis of rotation 5 chainring 25 for driving the crankset; it comprises, for example, at least one toothed wheel 27, 29 whereon a chain or transmission belt is engaged which drives in rotation at least one of the wheels of the bicycle, preferably the rear wheel, during the rotation of the chainring generated by the pedalling of the cyclist. The chainring 25 is arranged in a plane parallel to the plane “P” and is adjacent to one of the cranks 7, 9, preferably the right-hand crank 9. In a preferred and non-limiting embodiment, the chainring used is that having been the subject matter of the French patent application FR 05.00505.

The cranks 7, 9 are connected and attached to each other by a connecting spindle 31, shown in FIG. 1, the axle of which coincides with the axis of rotation 5 of the crankset 1; the attachment of the connecting spindle is produced at the axial ends 15, 17 of the cranks. The chainring 25 is rigidly connected to the cranks 7, 9 and the connecting spindle 31, the attachment of the chainring being carried out, in a preferred and non-limiting embodiment, on one of the cranks. The crank 7, 9, connecting spindle 31 and chainring 25 assembly is therefore rigidly connected and rotates at the same speed of rotation.

During pedalling by the cyclist, the radial ends 19, 21 of the cranks 7, 9 are subjected to radial forces and tangential forces; the tangential forces exerted on the radial ends 19, 21 are transferred to the connecting spindle 31 which is subjected to torsion stresses, then transferred to the chainring 25 enabling the rotation thereof and the driving of the chain or the transmission belt.

The crankset 1 is noteworthy in that it comprises assembly means pivotally connected between the axial ends 15, 17 of the cranks 7, 9 and the frame 3. Said, assembly means are arranged so that the axial ends 15, 17 of the cranks 7, 9 receive the ends of the housing of the frame 3, said ends of the frame 3 being inserted into the axial ends 15, 17 of the cranks 7, 9, which, on one hand, enables the frame 3 to directly support the forces exerted on the cranks 7, 9, and on the other hand, to move the position of the axial ends 15, 17 and the bodies 11 of the cranks 7, 9, same being positioned and integrated into the width of the housing of the frame 3. The purpose of said design of the crankset is to transfer to the frame 3 the radial forces to which are subjected the radial ends 19, 21 of the cranks during pedalling. Such a design is noteworthy in that it mechanically relieves the connecting spindle 31 by limiting the forces exerted on same during pedalling; indeed, the connecting spindle is mounted freely in the housing 33 of the frame 3 of the bicycle and is subjected only to the torsion stresses corresponding to the transfer of tangential forces of at least one of the cranks on the chainring 25.

The reduction of the stresses on the connecting spindle 31 of the crankset 1 to only torsion stresses, has the advantage of manufacturing said spindle 31 in a material lighter than steel, and in a preferred and non-limiting embodiment an aluminium alloy is used which suitably withstands torsion stresses.

Such a design assembly pivotally connected between the cranks 7, 9 and the frame 3 is also noteworthy in that it enables the distance “e” to be reduced, shown in FIG. 1, separating the axial ends 15, 17 of the cranks; indeed, the cranks 7, 9 are assembled directly on the lateral ends 35, 37 of the frame 3, which enables the length of the connecting spindle 31 to be reduced, as it no longer needs to support the cranks, as they are supported by the frame 3, the only functions thereof being to transmit the rotary motion on the chainring 25 and to maintain attached the cranks 7, 9 while respecting a pitch angle between same.

As shown in FIGS. 1 and 2, the means of assembling pivotally connected the cranks 7, 9 on the frame 3 in a preferred and non-limiting embodiment consists of two mounting rings 39, 41 on the frame 3, bearings 43, 45, axial ends 15, 17, and means for stopping the sliding motion of the cranks.

The mounting rings 39, 41 are attached via screwing on the lateral ends 35, 37 of the frame 3. For this, the lateral ends 35, 37 are tapped, and the rings 39, 41 have a first threaded end 47, 49 which ends with a shoulder 51, 53 acting as a stop on the frame 3, the second ends 55, 57 of the rings 39, 41 receive the inner housings 59, 61 of the bearings 43, 45 and therefore have a corresponding diameter, the outer housings 63, 65 of the bearings 43, 45 themselves being mounted in the axial ends 15, 17 of the cranks 7, 9, which have a bore shape 67, 69 with a diameter corresponding to same of the outer housing 63, 65 of the bearings enabling said outer housing to be received. The conditions for mounting the bearings 43, 45 in the bores 67, 69 and on the rings 39, 41 will preferably respect the trade practices for mounting the bearings known by the person skilled in the art.

In a preferred and non-limiting mode of design which is shown in. FIGS. 1 and 2, the connecting spindle 31 consists of the axial ends 15, 17 of the two cranks 7, 9 which extend towards the inside of the housing 33 of the frame 3 according to the axis of rotation 5, the two extensions 71, 73 having coupling means 75, 77 enabling the torsion farce to be transferred to the chainring causing the rotation thereof. Said coupling means 75, 77 are preferably implemented by grooves, one of the extensions 71 ending in the shape of a grooved conical spindle 75 constituting the male part which engages with the female part consisting of the second extension 73 which ends in the shape of a grooved conical hub 77.

The means for stopping in sliding motion the cranks 7, 9 enable them to be maintained, assembled and coupled, guaranteeing the suitable assembly of the crankset 1 on the frame 3 of the bicycle. Said means are obtained via the male extension 71 of the axial end 15 of the crank 7, i.e. the spindle 75, said extension 71 being hollow and tapped on the inner portion 79 thereof which receives a stop screw 81 penetrating inside 83 the female extension 73 of the axial end 17 of the second crank 9, i.e. the hub 77, the head 85 of the screw 81 bearing on a shoulder 87 produced inside 83 said extension 73, enabling the two axial ends 15, 17 to be maintained tightened to each other once the screw 81 has been assembled on the inner portion 79. In a preferred mode of assembly, the crankset comprises a preformed washer 86 shown in FIGS. 1 and 2 which enables the bearings 43 and 45 to be constrained and the various manufacturing tolerances of the frame 3 and the cranks 7 and 9 to be absorbed.

Such a design of the connecting spindle 31 provided directly by the axial ends 15, 17 of the cranks 7, 9, helps to reduce the quantity of material used to design the crankset 1 subject matter of the invention, and therefore tends to reduce the weight thereof. It may however be envisaged to separately design the connecting spindle which is integrated entirely inside the axial ends 15, 17 of the cranks 7, 9 and engages, in this case, with the shapes adapted and machined thereon, fulfilling the same functions as those described above.

The axial ends 15, 17 comprise indexing means, not shown in the figures, which enable the bodies 11, 13 of the cranks 7, 9 to be angularly adjusted at one hundred and eighty degrees in relation to each other. Said indexing means, in a preferred and non-limiting embodiment, consist of the grooves on the spindle 75 and on the hub 77, the grooves on the spindle 75 having for example at least one tooth with a different width than the other teeth and the grooves on the hub 77 having a hollow with a width corresponding to same of said tooth, said design requiring having said tooth opposite said hollow in order to enable the grooves of the spindle 75 to be engaged in same of the hub 77.

The extension 71 on the axial end 15 of the crank 7 has an outside diameter “D1” which, in a preferred and non-limiting mode of design, is equal to the outside diameter “D2” of the extension 73 on the axial end 17 of the crank 9. Said diameters “D1, D2” are smaller than the inside diameter “D3” on the rings 39, 41 so as to enable the insertion without friction of the extensions 71, 73 inside of said rings 39, 41.

According to a preferred embodiment, the chainring 25 is mounted on the axial end 15, 17 of one of the cranks 7, 9 which comprises an outside diameter 88 with toothing 89 for receiving the tooth 91 produced inside the chainring 25, said chainring being stopped in movement by means of a clamping nut 93 which is screwed on the threading 95 also produced on the outside diameter 88. Said mode of assembly is noteworthy in that it allows the possibility of angularly adjusting the chainring 25 in relation to cranks 7 and 9.

According to a preferred mode of design, the toothing 91 of the chainring 25 has the same pitch as the toothing 89 on one of the cranks 7, 9, said teeth 91, 89 having no locating pin so as to enable the pitch of the chainring 25 to be modified in relation to the cranks 7, 9 when said chainring 25 is not circular in shape so as to best adapt the adjustment of the crankset according to the morphology of the cyclist and his position on the bicycle. Said type of chainring is, for example, described in the patent application FR 05.00505.

In a preferred mode of design which is shown in FIG. 3, the pedals 23 of bicycle are mounted pivotally connected 97, and by direct assembly, on the radial ends 19, 21 of the cranks 7, 9; the pivot connection 97 consisting of at least one bearing 99 which is mounted directly between the pedal 23 and the crank 7, 9. The end of the pedal ends with a hollow axle 101, the outside diameter 103 of the axle 101 receiving the inner housing 105 of the bearing 99, the outer housing 107 of said bearing being inserted, into the bore 109 produced on the radial end 19, 21 of the crank 7, 9. The inside diameter 111 of the hollow axle 101 of the pedal 23 is tapped and receives via screwing a screw 113 for stopping in sliding motion the pedal 23 on the bearing 99, the shoulder 115 on the axle 101 and the head 117 of the stop screw 111 bearing on the lateral ends of the bearing 99 during the tightening of said screw 111. Said design is noteworthy in that it eliminates any additional assembly part, which consequently helps to reduce the weight of the crankset 1 of the present invention.

Other implementations of the crankset available to the person skilled in the art may be envisaged without deviating from, the scope of the present invention.

1. A bicycle crankset (1) such as for a bicycle, mounted in rotation on the frame (3) of said bicycle according to an axis of rotation (5) perpendicular to the plane “P” of the frame (3), said crankset (1) comprising two cranks (7, 9) arranged on either side of the plane “P” of the frame (3), of at least one driving chain ring (25) adjacent to one of the cranks (7, 9) and rigidly connected to same, said cranks (7, 9) receiving at their radial end (19,21) a pedal (23) and being connected by the axial end (15, 17) thereof to a connecting spindle (31) the axle of which corresponds to the axis of rotation (5) of the crankset (1), said connecting spindle (31) transferring to the chainring (25) the tangential forces exerted on the cranks (7, 9) during pedalling causing the rotation of said chainring (25), characterised in that the assembly of the crankset (1) on the bicycle is produced by the assembly means pivotally connected between the axial ends (15, 17) of the cranks (7, 9) and the frame (3) of the bicycle, said pivotally connecting assembly means consisting of two mounting rings (39, 41) attached to the frame (3), two bearings (43, 45), the axial ends (15, 17) of the two cranks (7, 9), and of the means for stopping in sliding motion the two cranks (7, 9), said bearings (43, 45) having the inner housing (59, 61) thereof mounted on the rings (39, 41), and the outer housing (63, 65) thereof mounted on the axial ends (15, 17) of the cranks (7, 9), on one hand, mechanically relieving the connecting spindle (31) and thus reducing the dimensions thereof, and on the other hand reducing the distance “e” between the axial ends (15, 17) of the cranks (7, 9).

2. A bicycle crankset (1) according to claim 1, characterised in that the axial ends (15, 17) have a bore shape (67, 69) for receiving the inner housing (63, 65) of the bearings (43, 45).

3. A bicycle crankset (1) according to claim 1, characterised in that the connecting spindle (31) consists of the axial ends (15, 17) of the cranks (7, 9), the axial end (15) of one of the cranks (7) comprises an extension (71) in the shape of a grooved conical spindle (75) which engages with the shape of a grooved conical hub (77) constituting the extension (73) of the axial, end (17) of the second crank (9).

4. A bicycle crankset (1) according to claim 3, characterised in that the axial ends (15, 17) of the cranks (7, 9) comprise indexing means consisting of the spindle and the grooved hub (75, 77) enabling the bodies (11, 13) of the cranks (7, 9) to be adjusted, to one hundred and eighty degrees (180°) in relation to each other.

5. A bicycle crank set (1) according to claim 3, characterised in that the means for stopping in sliding motion the cranks (7, 9) consist of a locking screw (81) which is bearing in the grooved hub (73) of the axial end (17) and is screwed on the grooved spindle (71) of the axial end (15).

6. A bicycle crankset (1) according to claim 1, characterised in that the axial end (15, 17) of one of the cranks (7, 9) comprises a toothing (89) and a threading (95), said toothing (39) engaging with a toothing (91) on the chainring (25), and said threading (95) receiving via screwing a clamping nut (93) of the chainring (25) on the crank (7, 9).

7. A bicycle crankset (1) according to claim 1, characterised in that the pedal (23) is mounted directly by means of a bearing (99) in the radial end (19,21), helping to reduce the weight of said crankset (1).

8. A bicycle crankset (1) according to claim 7, characterised, in that the inner housing (107) of the bearing (99) is mounted inside the radial end (19, 21) of the crank (7, 9) and the inner housing (105) of the bearing (99) is mounted on the pedal (23), the stop of the pedal (25) on the crank (7, 9) being produced by a screw locking the pedal (23) on the bearing (99), the screwing being produced directly on said pedal (23).

9. A bicycle crankset (1) according to claim 2, characterised in that the connecting spindle (31) consists of the axial ends (15, 17) of the cranks (7, 9), the axial end (15) of one of the cranks (7) comprises an extension (71) in the shape of a grooved conical spindle (75) which engages with the shape of a grooved conical hub (77) constituting the extension (73) of the axial end (17) of the second crank (9).

10. A bicycle crankset (1) according to claim 4, characterised in that the means for stopping in sliding motion the cranks (7, 9) consist of a locking screw (81) which is bearing in the grooved hub (73) of the axial end (17) and is screwed on the grooved spindle (71) of the axial end (15).

11. A bicycle crankset (1) according to claim 2, characterised in that the axial end (15, 17) of one of the cranks (7, 9) comprises a toothing (89) and a threading (95), said toothing (89) engaging with a toothing (91) on the chainring (25), and said threading (95) receiving via screwing a clamping nut (93) of the chainring (25) on the crank (7, 9).

12. A bicycle crankset (1) according to claim 2, characterised in that the pedal (23) is mounted, directly by means of a bearing (99) in the radial end (19,21), helping to reduce the weight of said crankset (1).
